(19) United States
(12) Patent Application Publication
(10) Pub. No.: US 2023/0182093 A1
(43) Pub. Date: Jun. 15, 2023

(54) SYSTEMS AND METHODS FOR HEATING AND MIXING OF COMPOSITIONS

(71) Applicant: Shiseido Company, Limited, Tokyo (JP)

(72) Inventors: Joel Stewart, Hayward, CA (US); David Michael Paul Espinoza, Saratoga, CA (US); Tejal J. Merchant, Cupertino, CA (US)

(73) Assignee: Shiseido Company, Limited, Tokyo (JP)

(21) Appl. No.: 18/081,843

(22) Filed: Dec. 15, 2022

Related U.S. Application Data
(63) Continuation of application No. PCT/IB2021/055571, filed on Jun. 23, 2021.
(60) Provisional application No. 63/043,614, filed on Jun. 24, 2020.

(51) Int. Cl. B01F 23/70; B01F 29/15; B01F 29/20

(52) U.S. Cl. CPC B01F 23/711; B01F 29/15; B01F 29/20; B01F 2101/21

(57) ABSTRACT

Methods and systems for producing personalized products are provided. The method involves placing a plurality of ingredients in a primary container, heating at least a portion of the primary container to a temperature selected to melt the ingredients, placing the heated primary container into a centrifuge, blending the melted ingredients into a substantially homogeneous mixture by spinning the primary container in the centrifuge, and allowing the substantially homogeneous mixture to cool to form a solid product.

### FIELD OF THE INVENTION

The field of invention is methods and systems for efficient heating and mixing of compositions, particularly compositions created in small batches and/or customized for a particular consumer or entity.

### BACKGROUND OF THE INVENTION

Many consumer products are mass-marketed as standard, non-unique items and, as such, are commercially produced in mass quantities. For example, commercial cosmetics are generally produced in batch processes involving large quantities of ingredients. For certain types of consumer items (e.g., cosmetics such as lipsticks), the ingredients are melted together, then mixed after melting by contact mixing processes (e.g., paddle mixers). Mixing large quantities of these melted ingredients to form a homogeneous substance is generally difficult to achieve without contact mixing. After mixing, the melted, mixed substance is poured into a number of individual molds and then de-aerated to remove unwanted air from the mixture imparted during the contact mixing process and pouring. The substance is allowed to cool in the molds to produce a number of non-unique cosmetic products with chemically identical contents, which are then sold for mass consumption. All implements that come into contact with the ingredients during the mixing process must then either be cleaned or discarded before another batch may be produced.

Consumers are becoming increasingly dissatisfied with mass produced products and demand personalized products that are tailored to the tastes and needs of individual consumers. This is particularly true in the cosmetics industry, where consumers seek products with personalized characteristics (e.g., shades, textures, ingredients). In addition, some entities wish to have produced small-batches of products according to the entity's particular criteria. Companies wish to respond to these demands by offering “small-batch” and/or personalized products that can be efficiently produced and sold for an affordable cost.

Traditional processes for manufacturing mass produced products that require heating and mixing are not well-suited for “small-batch” production of personalized products. For example, the processing of such large quantities of ingredients typically imparts resource-intensive requirements—i.e., contact mixing equipment must be thoroughly cleaned or discarded after use to ensure that forthcoming batches of ingredients are not contaminated by previous batches. This expends time and/or money, which may be appropriately spent in connection with production of mass quantities of a product, but is not an appropriate expenditure for “small-batch” production. Additionally, the mechanical contact-mixing processes needed to homogenize the large batches of ingredients often impart large quantities of air into the resulting mixtures, necessitating that the batches undergo extensive de-aeration processes, for example, lasting a minimum of 30 minutes, which adds further time and complication to batch production. In “small-batch” manufacturing, requiring an extensive de-aeration process prior to pouring into molds would result in significant processing inefficiencies and resulting costs.

Thus, appropriate processes and systems that work efficiently to produce “small-batch” and/or personalized products, and which do not involve the resource-intensive processing requirements of typical commercial batch production, are desired.

### BRIEF SUMMARY OF THE INVENTION

The present invention generally relates to methods and systems for producing products. One exemplary product is a cosmetic product and, more particularly, a cosmetic product that is produced in a “small-batch” and/or is personalized according to a particular consumer or entity. However, the invention is applicable to other products that require heating and mixing in their production and that would benefit from the processing efficiencies resulting from the inventive systems and methods disclosed herein.

More particularly, the methods involve placing a plurality of ingredients in a primary container, heating at least a portion of the primary container to a temperature selected to melt the ingredients, placing the heated primary container into a centrifuge, blending the melted ingredients into a substantially homogeneous mixture by spinning the primary container in the centrifuge, and allowing the substantially homogeneous mixture to cool to form a solid product.

In one embodiment, a portion of the primary container also serves as a mold, such that the substantially homogeneous mixture of ingredients is allowed to cool within the portion of the primary container to form a solid product, such as a cosmetic product.

In another embodiment, the substantially homogeneous mixture is poured from the primary container into one or more separate molds, such that the mixture is allowed to cool and solidify within the mold(s) to form solid product(s), such as cosmetic product(s).

### BRIEF DESCRIPTION OF THE SEVERAL VIEWS OF THE DRAWINGS

The foregoing summary will be better understood when read in conjunction with the appended drawings.

In the drawings:

FIG. 1 is a depiction of components of a primary container 100 in accordance with an exemplary system embodiment of the present invention;

FIG. 2 is a depiction of components (cup 2, puck 4, and jig 6) of a primary container 100 and a centrifuge bucket 20 in accordance with an exemplary system embodiment of the present invention;

FIG. 3 is a depiction of a primary container 100 and a centrifuge bucket 20 in accordance with an exemplary system embodiment of the present invention;

FIG. 4 is a depiction of a primary container 100 within a centrifuge bucket 20 in accordance with an exemplary system embodiment of the present invention.

FIG. 5A is a depiction of a jig 6 engaged with puck 4 and mantle 30 used to heat puck 4.

FIG. 5B is a depiction of a primary container disposed (partially) within a centrifuge bucket 20 and placed within a centrifuge 25.

FIG. 5C is a depiction of melted ingredients being poured from cup 2 into mold 8.

FIG. 5D is a depiction of the cup 2 that serves as a mold.

FIG. 6 is a depiction of a flowchart demonstrating a process of producing a product in accordance with an exemplary method embodiment of the present invention.

FIG. 7 is a depiction of a process of producing a product employing exemplary system components in accordance with an exemplary method embodiment of the present invention.

### DETAILED DESCRIPTION OF THE INVENTION

Methods and systems according the inventions herein may be suitable to produce small-batch and/or personalized products, such as those that require mixing and melting in their production. The exemplary embodiments are described herein with reference to production of cosmetics products such as cosmetic sticks (e.g., lip, eye or foundation/concealer sticks), but are applicable to production of other sorts of cosmetics products as well as other products that require melting and mixing processes as described herein.

In accordance with an exemplary embodiment of the present invention, a method of producing a product is provided. The method allows for customization of the resulting product to an individual's or entity's needs and tastes, reduces the costs and time consumption typically associated with large-batch commercial production, and resolves process inefficiencies that would result if traditional heating and mixing methods were employed in the production of small batch/individualized products.

The method includes placing a plurality of ingredients (e.g., cosmetic product ingredients) in a primary container. The plurality of ingredients placed into the primary container may have a total mass of between about 0.1 gram to about 500 grams, in the exemplary embodiment. In some embodiments, the total mass of the plurality of ingredients is less than about 40 grams, less than 40 grams, about 35 grams, about 30 grams, about 25 grams, about 20 grams, about 15 grams, about 10 grams, less than 10 grams, from 5 grams to 9 grams, from 4 grams to 8 grams, from 3 grams to 7 grams, from 3 grams to 5 grams, or from about 3.8 grams to about 4.2 grams, depending on the size and number of molds desired to be filled. In exemplary embodiments, the plurality of ingredients placed into the primary container has a total mass of less than 10 grams. At least a portion of the primary container is heated to a temperature selected to melt the plurality of ingredients. In one embodiment, at least a portion of the primary container may be heated prior to placing the plurality of ingredients therein.

The temperature to which the primary container or portion of the primary container is heated to melt the plurality of ingredients depends on the nature and quantity of the ingredients used. Those familiar with the properties of the ingredients used in making the product would recognize the appropriate temperatures to which a plurality of ingredients must be heated.

The primary container, at least a portion of which is heated, is then placed into a centrifuge, where the primary container is spun to blend the plurality of ingredients into a substantially homogeneous mixture. In some embodiments, the plurality of ingredients may only be partially melted when the primary container is placed into the centrifuge, such that the ingredients continue to melt during the mixing/blending process in the centrifuge. The homogenization of the plurality of ingredients is believed to be achieved as a function of appropriate melting heat, RPMs of the centrifuge, and time of centrifugation.

In some embodiments, the ingredients are subjected to centrifugation at between about 1000 RPMs to about 1800 RPMs. In further embodiments, the ingredients are blended in the centrifuge for between about 1 minute and about 3 minutes, up to a maximum of about 10 minutes. In certain embodiments, the blending step includes a total blending time of 2 minutes. In a particular embodiment, the ingredients are centrifuged at about 1000 RPMs for about 2 minutes. The spinning may be undertaken at a spin rate selected to achieve a selected gas content in the resulting solid product (i.e., to remove pockets of air during melting/blending in the centrifuge), and/or at a spin rate selected to achieve a substantially homogeneous mixture.

In exemplary embodiments, a FlakTek centrifuge mixing assembly may be used to spin and homogenize the ingredients (e.g., DAC 800 1 FVZ, or equivalent assembly). The mixing assembly used may have a mixing capacity of up to 700 g.

The nature of the centrifugation may take one of several forms. For example, in one embodiment, the primary container rotates around an axis through its center. In another embodiment, the primary container rotates around an axis that is external to the primary container. In such embodiments, the center axis of the primary container may be parallel to the external spin axis but, in other embodiments, the center axis of the primary container may be offset to the external spin axis. In still other embodiments, the primary container may rotate both around its center axis and about an external axis.

The inventors have surprisingly found that embodiments of the methods in which the plurality of ingredients melt during the blending step conserve time and energy by combining two steps, melting and blending, that would generally be separate steps in large batch commercial production due to the large amounts of ingredient materials being processed. Moreover, the avoidance of large-scale processing techniques, which generally utilize separate melting and blending steps, also provides other surprising benefits. For example, embodiments of the present invention avoid using mechanical blending means used by typical large batch commercial processes that contact the melted ingredients and impart large quantities of air during the contact mixing, reducing the time and energy needed to de-aerate the resulting blended ingredients. Additionally, since melting and blending of the plurality of ingredients are carried out simultaneously within the primary container in embodiments of the present invention such that the resulting substantially homogeneous mixture only comes into contact with the primary container itself, it is easier to clean only the primary container after use instead of an entire mechanical contact mixing apparatus.

Spinning (and blending) the small quantities of ingredients (e.g., 500 grams or less) in the primary container allows for any gas pockets within the blended ingredients to be removed during the spinning (and blending) step in the centrifuge, instead of employing a separate de-aerating step prior to pouring into molds. The process may, therefore, avoid a separate de-aeration step while achieving the same quality, de-aerated product as a mass-manufactured product. In some embodiments, the total gas content of the resulting substantially homogeneous mixture is less than 1% of its total volume, such that when the substantially homogeneous mixture is allowed to cool, the result is a finished solid product having a relatively low total gas content, e.g., of less than 1% of its total volume, in comparison to the typical post-blending total gas content yielded in large batch commercial production, which must typically be reduced in a further de-aeration step prior to pouring and cooling.

After the blending step, the substantially homogeneous mixture of the plurality of ingredients is allowed to cool to form a solid product. The cooled solid product has a hardness that is within the acceptable range and consistent with those products manufactured in a mass-produced process. In some embodiments, the substantially homogeneous mixture is allowed to cool within the primary container. In embodiments where the substantially homogeneous mixture is cooled within the primary container, at least a portion of the primary container may serve as a mold.

In other embodiments, the substantially homogeneous mixture is poured into one or more molds after blending prior to allowing the mixture to cool, such that the substantially homogeneous mixture is allowed to cool within the one or more molds to form a solid product. In these embodiments, at least a portion of the primary container preferably has at least one spout dimensioned to direct the substantially homogeneous mixture from the primary container into the mold(s).

In embodiments in which the blended ingredients are poured into a mold separate from the primary container, and the product is a lipstick product, the mold may have a volume between about 3.5 and about 4 ml, holding about 4 grams of the mixture. In certain embodiments, the primary container holds a volume of blended ingredients that is greater than the volume of the mold(s). In some embodiments, the primary container holds a volume of blended ingredients that is capable of filling from about 1 up to about 125 molds (e.g., where a maximum of about 500 grams of ingredients held in the primary container, where each mold holds about 3.8 grams of the mixture).

In some embodiments of the invention, a mold that is separate from the primary container may be pre-heated prior to the blended ingredients being poured therein. The mold may be pre-heated to temperatures of between 120° C.-200° C. In some embodiments, the mold may be placed upon a hot plate to heat to the desired temperature. In further embodiments, the mold may be encased in a sleeve and heated to temperature by conduction through a hot plate, such that the hot mold is not exposed to the surroundings. The sleeve encasing the mold remains cool to the touch and safe for handling to allow the mold to be moved by human contact without fear of causing burns.

The inventors have found that the methods and systems of the present invention are especially suited to producing personalized (to a consumer or entity), small-batch products, including cosmetics products. Embodiments of the methods in which the compositional ingredients of the products are both melted and mixed/blended during centrifugation are generally not suitable for using the large quantities of ingredients generally used in large-batch commercial production. It is believed that such large quantities would not properly melt and blend in methods and processes according to the present invention.

### Systems According to the Invention

In accordance with an exemplary embodiment of the present invention, mechanical systems for producing products are now described.

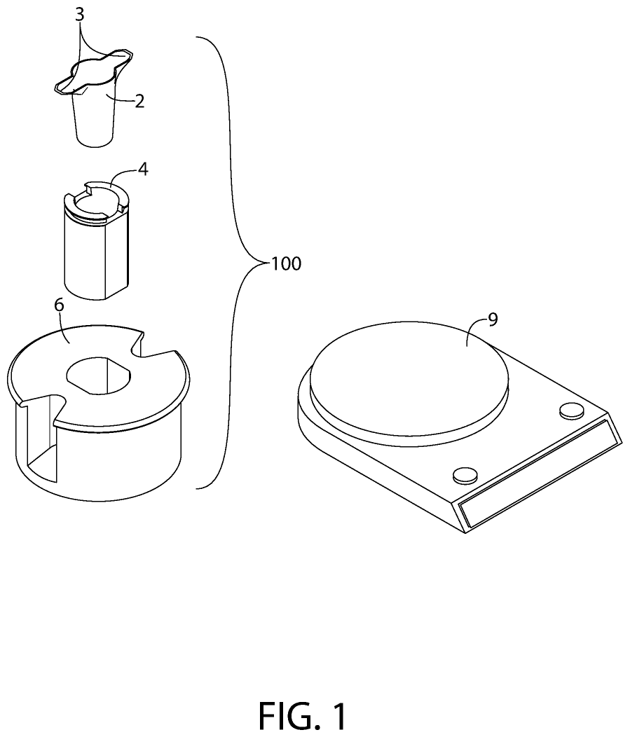

As a non-limiting illustration, FIG. 1 depicts components of a primary container 100 in accordance with an exemplary system. A cup 2 of the primary container 100 is provided to receive the plurality of ingredients chosen to make a product. The cup 2 may be composed of stainless steel, or any suitable non-reactive, heat tolerant/heat conductive material. The cup 2 may also have spouts 3 to allow for pouring homogenized ingredients after centrifugation. The spouts 3 may be symmetrical to prevent weight imbalances during centrifugation. In some embodiments, the cup 2 may also serve as a mold itself, without spouts. In some embodiments, the spout geometry is selected to permit the pouring of material from the spout while the primary container is disposed within an outer housing (e.g., a jig as described below) that provides an insulated surface configured and dimensioned to permit a hand hold for a user. In some embodiments, the spout is configured to extend beyond a portion of the outer surface of the outer housing.

A heat-conducting puck 4 of the primary container 100 is provided. The puck 4 may comprise a metal material, such as aluminum, copper or stainless steel, but preferably a metal material that can be cleaned easily. The puck 4 may be heated to a selected temperature; in some embodiments, the puck 4 is placed on a hot surface 9 (e.g., a hot plate as shown or placed in a water bath, not shown) to increase the temperature of the puck 4 to a suitable level. The puck 4 may be heated to a temperature sufficient to melt ingredients placed in the cup 2 (when cup 2 is disposed within puck 4). For example, the temperature of puck 4 may be selected based upon the thermal conductivity of puck 4 and cup 2 to ensure that the material disposed within cup 2 reaches the selected temperature.

In some embodiments, the heated puck 4 is configured to receive the cup 2, such that the non-reactive cup 2 may be inserted and removed from a cavity in the heat conductive puck 4. The heat conductive puck 4 may include an inner wall defining a portion of the cavity. The non-reactive cup 2 may include an outer wall radially disposed about a center axis of the non-reactive cup 2, wherein the outer wall of the non-reactive cup 2 is configured and dimensioned to mate to and engage the inner wall of the puck 4 when the non-reactive cup 2 is placed within the conductive puck 4. The inner wall of the conductive puck 4 and the outer wall of the cup 2 may be tapered such that the non-reactive cup 2 seats into the cavity of the puck 4 in a tight tolerance configuration. The non-reactive cup 2 may be shaped to seat within the conductive puck 4 to prevent the non-reactive cup 2 from rotating relative to the puck 4.

In other embodiments, the non-reactive cup 2 is integral with the conductive puck 4, such that they form a unitary piece.

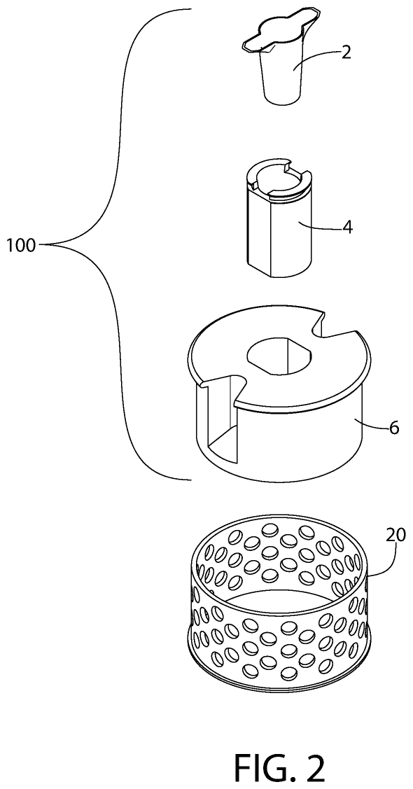

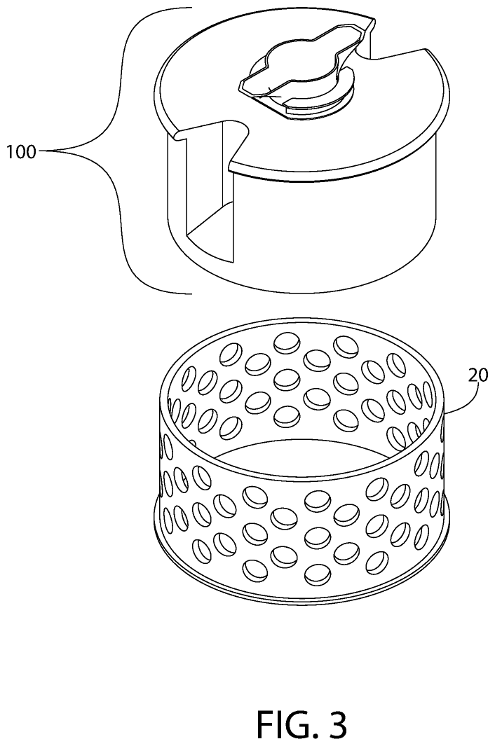

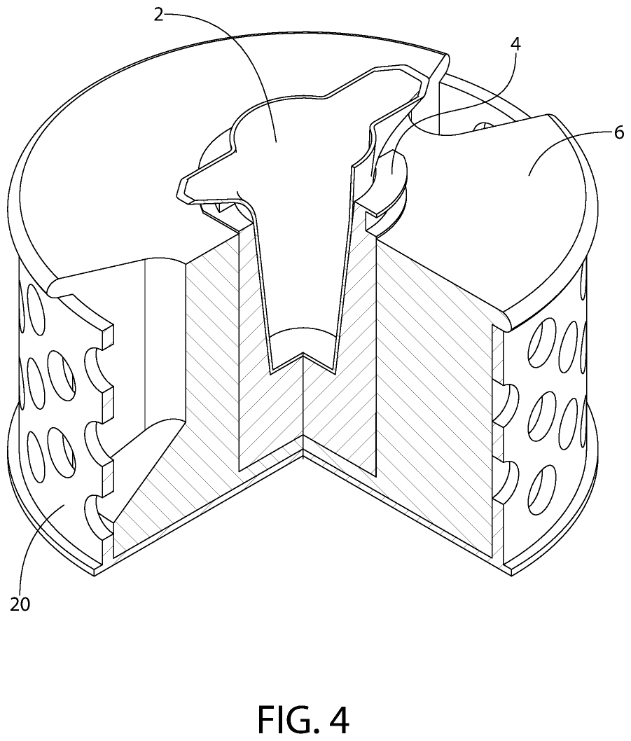

The primary container 100 also comprises a non-heat conductive jig 6. A jig 6 of the primary container 100 is provided to receive or substantially surround the heated puck 4 (i.e., the heated puck 4, a portion of the primary container 100, can be disposed within the non-conductive jig 6). Thus, the puck 4 is at least substantially disposed within the jig 6 prior to any blending step. The jig 6 is composed of a thermally non-conductive material (e.g., silicon, polyethylene terephthalate (PET), or polyether ether ketone (PEEK)). With reference to FIGS. 2-4, in some embodiments the puck 4 is placed into the jig 6 when the puck 4 reaches a suitable temperature. The jig 6 may include alignment features that can mate with corresponding features of the centrifuge and/or one or more notches configured to mate with corresponding features on the puck 4 to prevent the puck 4 from rotating within the jig 6.

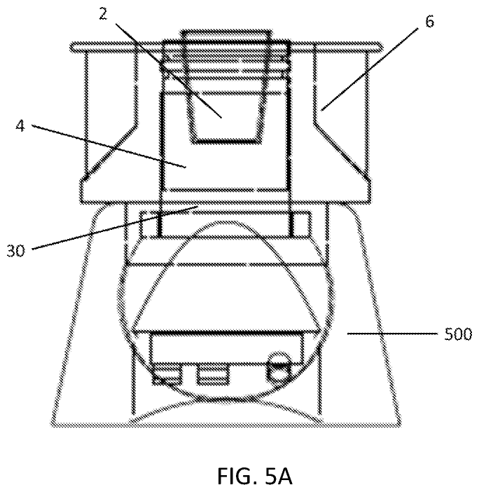

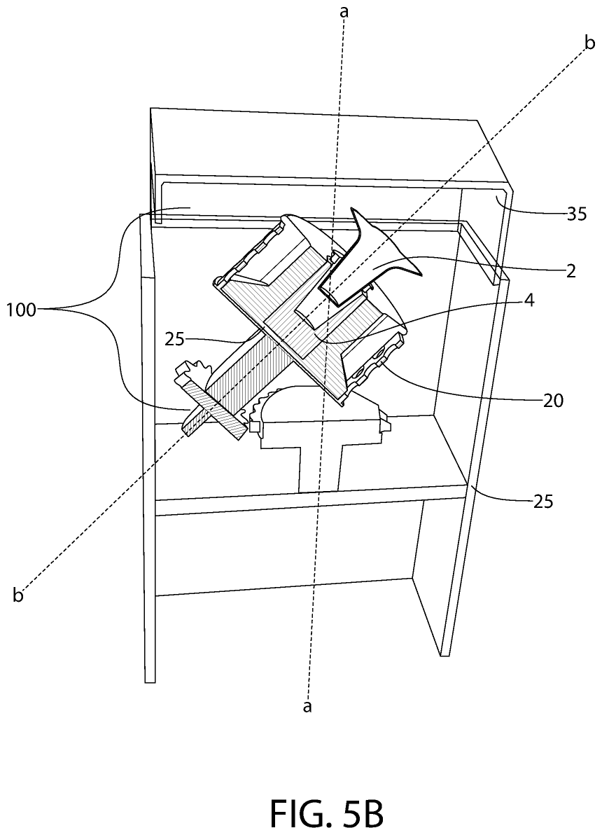

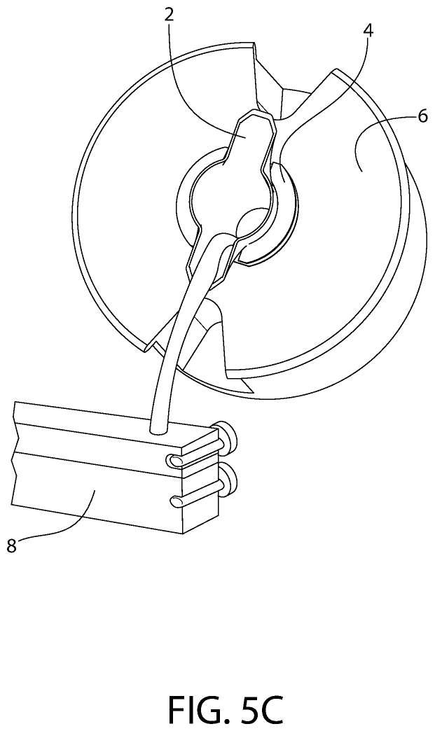

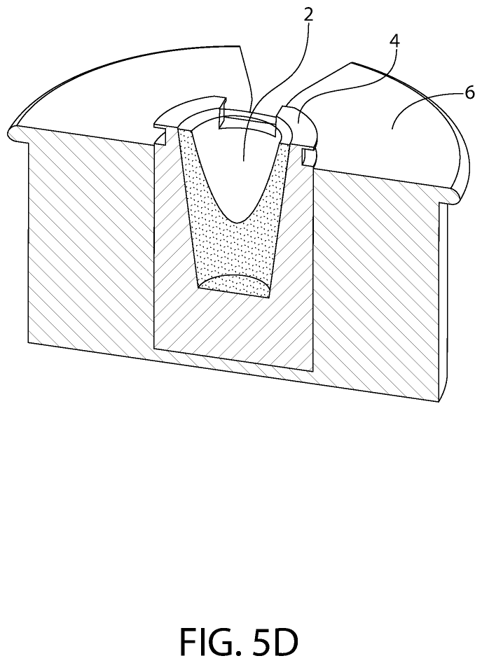

In an alternate embodiment, shown in FIG. 5A, the jig 6 has a cylindrical opening through its center (i.e., the bottom of jig 6 is not closed off as shown in FIGS. 1-4). In this embodiment, puck 4 may be disposed within the cylindrical opening prior to heating and the entirety of that unit (i.e., puck 4 plus jig 6) may be placed on the mantle 30 of a heating unit 500. The puck 4 is heated by way of the mantle 30, which is disposed within jig 6, while jig 6 remains cool to touch.

In further embodiments of the system, the puck 4 may be substantially or completely surrounded by and/or integral with the jig 6, such that the puck 4 is heated by induction. The puck 4 within the jig 6 may be placed on an induction coil to heat the puck 4. The induction coil generates an electromagnetic field that induces a current in the conductive puck 4 to produce heat, while the jig 6 is thermally non-conductive and insulates the puck 4. This shields the hot puck 4 from the surroundings and may increase safety when handling the heated puck 4, as the jig 6 is cool to the touch (while the puck 4 inside is hot).

When the hot puck 4 is in the jig 6, the non-reactive cup 2 is placed within a cavity in the puck 4 to engage with the heated puck 4, such that the ingredients within the cup 2 are allowed to melt.

In some embodiments, the cavity of the puck 4 is not as deep as the cup 2 is tall, such that when the cup 2 is placed within the cavity of the puck 4, it protrudes from the cavity. This allows for easy removal of the cup 2 from the puck 4.

When all components (cup 2, puck 4, and thermally insulating jig 6) of the primary container 100 are in place, the primary container 100 may be placed into a centrifuge bucket 20. The primary container 100 is therefore disposed with the centrifuge bucket 20 prior to blending in the centrifuge. The centrifuge bucket 20 is a receptacle that may be shaped to align with the primary container 100 to prevent the primary container 100 from rotating when disposed within the centrifuge bucket 20 and to align selected features of the primary container 100 to selected features of the centrifuge bucket 20. The centrifuge bucket 20 containing the primary container 100 is then placed within the centrifuge, where the primary container 100 can be spun to blend the ingredients within cup 2. The substantially non-heat conductive jig 6 serves as a form of insulation for the puck 4, shielding the puck 4 from outside conditions and allowing the puck 4 to retain a suitable or pre-selected temperature/temperature variance in order to melt the plurality of ingredients during blending; the jig 6 also allows for safe handling of the heated puck 4. In some embodiments, the jig 6 of the primary container 100 includes alignment features that mate with corresponding features of the centrifuge bucket 20 to permit reproducible alignment of the jig 6 with the centrifuge.

The components of a primary container 100 in accordance with embodiments of the invention generally have equal weight distribution and symmetry to undergo proper centrifugation. Additionally, the maximum mass of the primary container 100 must stay within the limits permitted by the centrifuge bucket (e.g., a maximum of 800 grams). The cup 2 may protrude from the puck 4 for ease of removal. Also, the cup 2/puck 4 may employ a cam or notch system to ensure the cup 2 remains in place during pouring if the entire primary container 100 is tilted to pour the blended ingredients after centrifugation. As the cup 2 is designed to heat during centrifugation, the cup 2 may also be designed to have tight tolerances within the puck 4, to ensure that the cup 2 does not exit the cavity within the puck 4 during centrifugation or pouring. Moreover, the cup 2 may be designed with a predetermined coefficient of expansion under exposure to heat from the puck 4, which also may be calculated into the means by which the cup 2 stays in place within the puck 4.

The ingredients within the cup 2 melt during centrifugation from the heat of the puck 4, which is transferred into the cup 2.

As mentioned previously, there are various configurations for centrifugation as illustrated in FIG. 5B. As seen in FIG. 5B, which is a cross-sectional view, primary container 100 (showing in a modified exploded view for ease of illustration) is placed within centrifuge 25. Primary container 100 has an internal axis bb and an external axis aa. Internal axis bb is offset at an angle that is between about 30° to about 90°, preferably about 45°, in relation to an axis that is perpendicular to the external axis aa. In some embodiments, internal axis bb may be parallel to external axis aa.

In certain embodiments and centrifuges/mixing assemblies (e.g., a FlackTek SpeedMixer DAC 800.1 FVZ), the mixing/blending is carried out by the spinning of a high speed mixing arm in one direction, while the centrifuge bucket rotates in an opposing direction. It is believed that offsetting the primary container in the centrifuge bucket at an angle applies a combination of forces in different planes that enables very fast mixing, including a shearing force to the mixture of ingredients that pushes the mixture toward the center of the centrifuge, which may help to blend and homogenize the melted ingredients within the cup 2. Centrifuge 25 may include a lid 35 to prevent any melted ingredients from escaping from centrifuge 25 during the centrifugation process.

When the ingredients within the cup 2 are homogenized through centrifugation, in some embodiments, the blended ingredients may be poured into a separate mold 8, as illustrated in FIG. 5C. There may be a volume of homogenized ingredients within the cup 2 that is greater than the volume of the separate mold 8, which may provide for an excess volume of homogenized ingredients remaining in the cup 2 after pouring. The non-conductive jig 6 of the primary container 100 may be configured, according to its composite materials, to allow a user to handle the non-conductive jig 6 while pouring the substantially homogeneous mixture into a mold.

The separate mold 8 may be pre-warmed (e.g., with a hot plate). The pre-warmed separate mold 8 is then allowed to cool with the homogenized ingredients therein to yield a solidified product. In some embodiments, the separate mold 8 is substantially or completely covered/surrounded by a thermally non-conductive sleeve, and the mold 8 is heated via conduction (e.g., by being placed within the sleeve upon a hot plate). In these embodiments, the separate mold 8 is shielded from the surroundings, which increases the safety during handling of the mold 8. In other embodiments, while pre-warming, the mold 8 and warming mechanism (e.g., hot plate) are covered with a clear acrylic box to protect from accidental contact with hot surfaces.

In some embodiments, the non-reactive cup 2 comprises a mold configured and dimensioned to form the solid product having a preselected configuration; i.e., the cup 2 serves as a mold itself, as shown in FIG. 5D. The cup 2 comprising a mold may form a solid product having any preselected configuration, e.g., a tube-shaped or bullet-shaped lipstick, or other shaped cosmetic stick. Thus, after melting and centrifugation, the cup 2 may be removed from the puck 4, or may remain in the puck 4, and the homogenized ingredients are allowed to cool within the cup 2 to yield the solidified product. In embodiments in which the cup 2 is also a mold, the cup 2 comprises one or more suitable heat-conductive materials that also serve as suitable mold materials. Example of suitable materials for heat conduction and molds include, but are not limited to, flurosilicone, silicone, anodized aluminum, and stainless steel. When the cup 2 also serves as a mold, the cup 2/mold may be placed into a chilling table or freezer to allow the homogenized ingredients to cool and solidify within a short time.

### Methods According to the Invention

In accordance with an exemplary embodiment of the present invention, methods for producing products are provided. In an exemplary embodiment, the product is a cosmetic product.

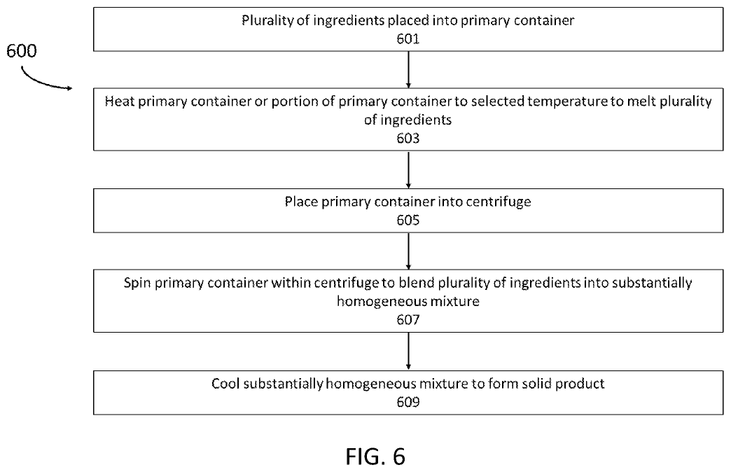

FIG. 6 depicts method 600 of producing products in accordance with aspects of the present invention. At step 601, a plurality of ingredients selected to comprise the product(s) is placed into a primary container. In some embodiments, the ingredients may be selected to form a cosmetic product that is customized based on input received from or about a consumer or entity. The primary container or at least a portion of the primary container is heated at step 603 to a temperature selected to melt the ingredients placed within the primary container. Step 603 may be carried out before or after step 601. The primary container may include a non-reactive cup, a thermally conductive puck, and an insulated, non-heat conductive jig. The plurality of ingredients may be placed into the non-reactive cup. The thermally conductive puck, which may be heated to a selected temperature to melt the ingredients within the cup, may include a cavity into which the cup may be inserted to allow the ingredients to melt. The jig, another portion of the primary container, may substantially or completely surround the puck so as to prevent exposure of the heated puck to the open air.

At step 605, the primary container is placed into a centrifuge, such that the primary container or at least a portion of the primary container is heated to the selected temperature at the time the primary container is placed into the centrifuge. The primary container may be placed into a centrifuge bucket during step 605, then placed into the centrifuge. The plurality of ingredients within the primary container (e.g., within the cup) may only be partially melted when placed into the centrifuge.

At step 607, the primary container within the centrifuge is spun to blend the ingredients. The plurality of ingredients may also melt while blending inside the primary container. The ingredients blend during spinning into a substantially or completely homogeneous mixture.

At step 609, the substantially or completely homogeneous mixture is allowed to cool to form a solid product. The mixture may be allowed to cool within the primary container or a portion of the primary container (e.g., it may cool within a cup of the primary container, which serves a dual purpose as a mold), or it may be poured into a separate mold and allowed to cool and solidify.

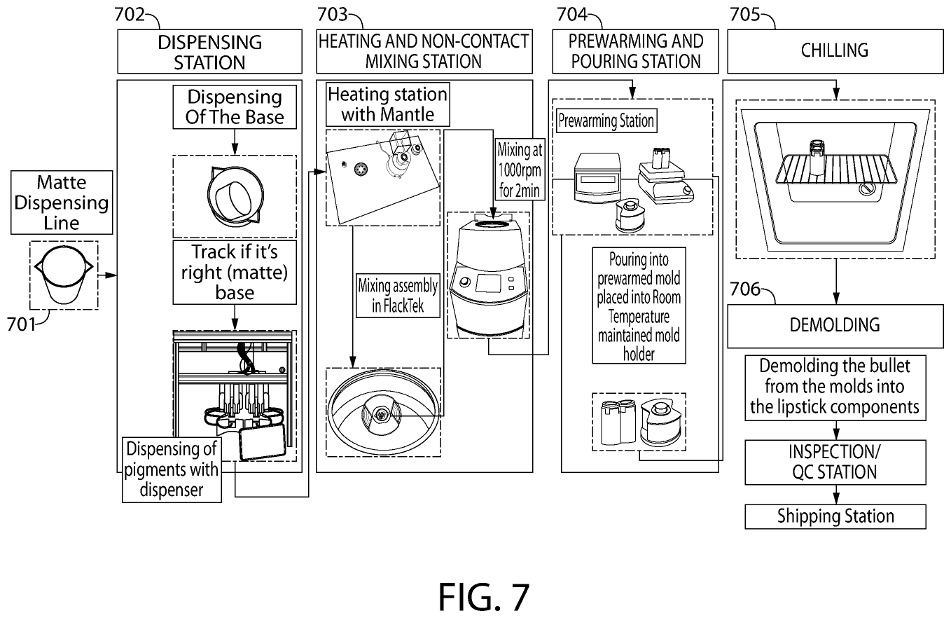

FIG. 7 depicts a method 700 of producing cosmetic products in accordance with aspects of the present invention. At step 701, empty cup 2 may be labeled with an identification code to enable tracking of the cup 2. The label may also include information related to the particular ingredients chosen for addition to the cup for a customized production process. Thus, the cup 2 may be labeled with both identification for tracking and with customization ingredients and parameters.

At step 702, the cup 2 moves to a dispensing station, where a number of ingredients for making the cosmetic product are dispensed into the cup 2. The ingredients may include bases and pigments to be melted.

At step 703, the cup 2 may be placed inside a heat-conducting puck 4. The puck 4 may be heated to a selected temperature; in some embodiments, the puck 4 is placed on a hot surface 9 (e.g., a hot plate as shown or placed in a water bath, not shown) to increase the temperature of the puck 4 to a suitable level. The puck 4 may be heated to a temperature sufficient to melt the cosmetic ingredients placed in the cup 2. The cup 2 may be inserted and removed from a cavity in the heat conductive puck 4, or the cup 2 may be integral with the conductive puck 4, such that they form a unitary piece.

A jig 6 may also be provided to receive or substantially surround the heated puck 4 (i.e., the heated puck 4 can be disposed within the non-conductive jig 6). Thus, the puck 4 may be substantially disposed within the jig 6. The puck 4 may be placed into the jig 6 when the puck 4 reaches a suitable temperature. Alternatively, the puck 4 may be disposed within a cylindrical opening of the jig 6 prior to heating the puck 4, such that the entirety of a unit comprising puck 4 plus jig 6 may be placed on a mantle of a heating unit. The puck 4 is heated by way of the mantle, which is disposed within jig 6, while jig 6 remains cool to touch.

In yet another embodiment, the puck 4 may be substantially or completely surrounded by and/or integral with the jig 6, such that the puck 4 is heated by induction. The puck 4 within the jig 6 may be placed on an induction coil to heat the puck 4.

When all components (cup 2, puck 4, and jig 6) are assembled, the unit (forming a primary container 100) may be placed into a centrifuge bucket 20. The centrifuge bucket 20 containing the primary container 100 is then placed within the centrifuge, where the primary container 100 can be spun to blend the ingredients within cup 2. The ingredients within the cup 2 melt during centrifugation from the heat of the puck 4, which heat is transferred into the cup 2.

At step 704, the heated and blended ingredients within the cup 2 are poured into one or more molds 8. The molds 8 may be pre-warmed (e.g., using a hot plate), or may be room temperature when the substantially homogenized contents of the cup 2 are poured therein. At this point, an identification label from cup 2 may be transferred to the mold 8 or duplicated and applied to mold 8 to ensure that the contents remain properly identified.

At step 705, the contents of the mold(s) 8 are chilled to allow the substantially homogeneous contents to solidify into the desired cosmetic product. At step 706, the solidified cosmetic product is removed from the mold 8. The product may be inspected for quality, and an identification label from the mold 8 may be transferred to the cosmetic product or duplicated and applied to the product to ensure that the product remains properly identified for shipping/transport.

It will be appreciated by those skilled in the art that changes could be made to the exemplary embodiments shown and described above without departing from the broad inventive concepts thereof. It is understood, therefore, that this invention is not limited to the exemplary embodiments shown and described, but it is intended to cover modifications within the spirit and scope of the present invention as defined by the claims. For example, specific features of the exemplary embodiments may or may not be part of the claimed invention and various features of the disclosed embodiments may be combined. Unless specifically set forth herein, the terms “a”, “an” and “the” are not limited to one element but instead should be read as meaning “at least one”. The term “comprising” and similar terms are considered open-ended.

It is to be understood that at least some of the figures and descriptions of the invention have been simplified to focus on elements that are relevant for a clear understanding of the invention, while eliminating, for purposes of clarity, other elements that those of ordinary skill in the art will appreciate may also comprise a portion of the invention. However, because such elements are well known in the art, and because they do not necessarily facilitate a better understanding of the invention, a description of such elements is not provided herein.

Further, to the extent that the methods of the present invention do not rely on the particular order of steps set forth herein, the particular order of the steps should not be construed as limitation on the claims. Any claims directed to the methods of the present invention should not be limited to the performance of their steps in the order written, and one skilled in the art can readily appreciate that the steps may be varied and still remain within the spirit and scope of the present invention.

What is claimed is:

1. A method of producing a product comprising:
placing a plurality of ingredients in a primary container;
heating at least a portion of the primary container to a temperature selected to melt the ingredients;
placing the heated container into a centrifuge;
blending the melted ingredients into a substantially homogeneous mixture by spinning the primary container; and
allowing the substantially homogeneous mixture to cool to form a solid product.

2. A method of producing a product comprising:
placing a plurality of ingredients in a primary container, the plurality of ingredients having a total mass of has a total mass of between about 0.1 grams to about 500 grams;
heating at least a portion of the primary container to a temperature selected to melt the ingredients;
blending the plurality of ingredients as the plurality of ingredients melt to form a substantially homogeneous mixture, in a manner such that the resulting melted plurality of ingredients only contact the primary container during the blending homogeneous; and
allowing the substantially homogeneous mixture to cool to form a solid product having a total gas content of less than 1% by volume.

3. The method of claims 1 and 2 wherein the primary container includes a non-reactive cup and a heat conductive puck.

4. The method of claim 3 wherein heating at least a portion of the primary container comprises:
heating the conductive puck to the selected temperature; and
placing the non-reactive cup with the plurality of ingredients contained therein into engagement with the heated conductive puck.

5. The method of claim 1 further comprising pouring the substantially homogeneous mixture into a mold prior to allowing the homogeneous mixture to cool to form a solid product.

6. The method of claim 1 or 2 wherein the plurality of ingredients placed into the primary container has a total mass of less than 500 grams.

7. The method of claim 3 wherein the non-reactive cup is integral with the conductive puck.

8. The method of claim 3 wherein the non-reactive cup is insertable into and removable from a cavity in the conductive puck.

9. The method of claim 8 wherein the conductive puck includes an inner wall defining a portion of the cavity and the non-reactive cup comprises an outer wall radially disposed about a center axis of the non-reactive cup, the outer wall of the non-reactive liner configured and dimensioned to mate to the inner wall of the conductive puck when the non-reactive cup is placed within the conductive puck.

10. The method of claim 9 wherein the inner wall of the conductive puck and the outer wall of the non-reactive cup are tapered and wherein the non-reactive cup seats into the cavity in a tight tolerance configuration.

11. The method of claim 3 wherein the non-reactive cup comprises a mold configured and dimensioned to form the solid product having a preselected configuration.

12. The method of claim 1 wherein the spinning is undertaken at a spin rate selected to achieve a selected gas content in the solid product and/or achieve a homogeneous mixture.

13. The method of claim 12 wherein the gas content achieved upon spinning and hardening to a solid product, without a further deaeration step, is less than 1 percent of the total volume of the solid product.

14. The method of claims 1 and 2 wherein the blending step includes a total blending time of from about 1.8 minutes to about 2.2 minutes.

15. The method of claim 1 wherein the primary container comprises a non-heat conductive jig, such that the heated at least a portion of the primary container is disposed within the non-heat conductive jig prior to the blending step; and wherein the non-heat conductive jig of the primary container is configured to allow a user to handle the primary container while pouring the substantially homogeneous mixture into a mold.

16. The method of claim 15 wherein the jig includes alignment features that are matable with corresponding features of a centrifuge bucket to permit reproducible alignment of the jig with the centrifuge bucket.

17. The method of claim 3 wherein the non-reactive cup is shaped to seat within the heat conductive puck to prevent the non-reactive cup from rotating relative to the heat conductive puck.

18. The method of claim 3 wherein the primary container is disposed within a centrifuge bucket prior to the blending step, wherein the centrifuge bucket includes a receptacle that is shaped to align with at least a portion of the primary container to prevent the primary container from rotating when disposed within the centrifuge bucket and to align selected features of the primary container to selected features of the centrifuge bucket.

19. The method of claim 5, wherein the primary container has at least one spout dimensioned to direct the homogeneous mixture from the primary container into the mold.

20. The method of claim 5, wherein the mold has a total volume of about 4.0 mL to about 5.0 mL.
